(19) United States
(12) Patent Application Publication
(10) Pub. No.: US 2011/0259818 A1
(43) Pub. Date: Oct. 27, 2011

(54) FILTER MEDIA FOR LIQUID PURIFICATION TO REMOVE TRACE METALS

(75) Inventors: Masao Tamada, Takasaki-Shi (JP); Noriaki Seko, Takasaki-Shi (JP); Yuji Ueki, Takasaki-Shi (JP); Toshihide Takeda, Osaka (JP); Masanori Nakano, Osaka (JP); Shin-ichi Kawano, Atsugi-shi (JP); Mitsugu Abe, Atsugi-shi (JP); Kiyokazu Miyagawa, Atsugi-shi (JP)

(73) Assignees: JAPAN ATOMIC ENERGY AGENCY, Naka-gun (JP); NOMURA MICRO SCIENCE CO., LTD., Atsugi-shi (JP); KURASHIKI TEXTILE MANUFACTURING CO. LTD., Osaka (JP)

(21) Appl. No.: 13/092,447

(22) Filed: Apr. 22, 2011

(30) Foreign Application Priority Data
Apr. 26, 2010 (JP) 2010-100637

(51) Int. Cl. B01D 39/16

(52) U.S. Cl. 210/502.1; 210/500.1

(57) ABSTRACT

Filter media for liquid purification, which can remove metal compounds or metal ions containing in polishing or washing liquids such as alkali, acid solution or ultra-pure water used for silicon wafers of semiconductors. Removal of metals from various kind of liquid such as inorganic chemicals, organic solvent, or industrial waste water are also the subject of the present invention.

The Filter media made of melt-blown nonwoven substrate comprising of aethylene/norbornene copolymer represented by the following formula [1] and/or a polycyclic norbornene polymer represented by the following formulae [2](a),(b),(c) as raw material, wherein said ethylene/norbornene copolymer and said polycyclic norbornene polymer have a glass transition temperature (Tg) selected in a range from 80 to 180° C. and melt volume rate (MVR) (ISO 1133, measuring conditions: 260° C., 2.16 kg) of 30 cm³/10 min or more, and wherein said melt-blown nonwoven substrate is constituted of fibers having an average fiber diameter ranging from 1 to 30 μm is applied. On such melt-blown nonwoven substrate, ion-exchangeable or chelate group is introduced through graft polymerization of vinyl monomer.

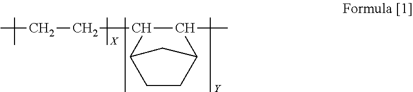

[wherein ethylene unit (X) and norbornene unit (Y) is chosen from 1 to 99 mole %]

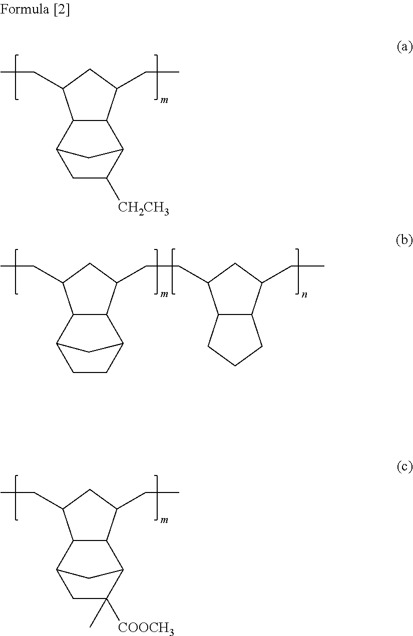

[wherein m and n represent degree of polymerization and are chosen from 1 or more.]

### BACKGROUND OF THE INVENTION

1. Field of the Invention

The present invention relates to filter media for liquid purification, which can remove metal compounds or a metal ions containing in liquid such as alkali solution or ultra-pure water for polishing or washing silicon wafers used for semi-conductors. Purification of other kind of liquid industrially used such as inorganic chemicals, organic solvents and industrial effluents are also the subject of this invention.

2. Description of the Prior Art

In most cases, metal compounds and metal ions containing in chemical liquid and ultra-pure water used for semi-conductor production are mostly brought by elution from metals used in pipelines, towers, vessels and tanks in the production facilities.

Such metal-contained chemical liquid or pure-water causes deterioration of quality and decrease in yield of the production, therefore, removal of trace metals such as Ni, Cu, Zn, Fe, Na, Mg, Cr and Al from the chemical liquid and pure-water has been demanded.

As a means conventionally applied for collecting/removing trace metals or metal compounds contained in liquid, ion-exchange resins of bead-like particle have been used in such way that the particles are packed in a column or combined with porous membrane as a filter unit for purification of the liquid.

By another means for metal removal, nonwoven filter media made of high density polyethylene (HDPE) on which functional monomer is grafted has been applied as shown in Patent Literature 1, 2 and 3.

For instance, in case of ion-exchange resins, metal containing liquid diffuses into porous structure of bead-like resins and come into contact with ion-exchange group or chelate group which adsorb metal ions. Accordingly, the rate and amount of metal adsorption depend on the rate of diffusion of the liquid into the bead-like resins, therefore, a large amount of ion-exchange resins is required when high rate of metal removal is expected.

From this point of view, a nonwoven filter media composed of fine fibers having functional monomer capable of metal adsorption is advantageous than ion-exchange resins, because nonwoven fabrics composed of large number of fibers have large specific surface area which can more effectively contact with liquid than ion-exchange resins.

In addition, such nonwoven type of filter media can be easily pleated or winded to make a compact “cartridge unit” to provide large filtration surface area for liquid purification.

As a preferable raw material for such nonwoven filter media, HDPE has been used, because HDPE is not easily deteriorated by irradiation and causes less molecular scission. Moreover, radicals generated by irradiation are well preserved in HDPE nonwoven when it is kept at low temperature, therefore, HDPE nonwoven has been applied for graft polymerization with functional monomer.

### Prior Art Literatures

[PATENT LITERATURE 1]: JP-A-11-279945;

[PATENT LITERATURE 2]: JP-A-9-99221;

[PATENT LITERATURE 3]: JP-A-5-131120.

Moreover, HDPE itself is water-repellent and is excellent thermal and chemical stability, therefore, it has been considered that HDPE is one of the most suitable material for liquid filtration.

However, such HDPE material applied for the substrate of the filter media has following shortcomings. That is, when HDPE contacts with a chemical having high extracting power like strong alkali, acid or organic solvent, residual catalysts as metal compounds remained in HDPE are easily eluted to liquid. Such metal elution is not negligible and become harmful to the production of high quality semi-conductors and/or other electric devices.

Just for reference, results of metal analysis on HDPE resin are shown below in Table 1.

TABLE 1
Amounts of metals contained in HDPE, COC and COP resin

Unit: μm/g (ppm)

| Kind of | | | |
|---|---|---|---|
| Metal | HDPE | COC | COP |
| Na | 1 | <0.5 | <0.5 |
| Mg | 140 | <0.5 | <0.5 |
| Al | 70 | <0.5 | <0.5 |
| K | <5 | <5 | <5 |
| Ca | 1 | <0.5 | <0.5 |
| Cr | <0.5 | <0.5 | <0.5 |
| Mn | <0.5 | <0.5 | <0.5 |
| Fe | <0.5 | <0.5 | <0.5 |
| Ni | <0.5 | <0.5 | <0.5 |
| Cu | <0.5 | <0.5 | <0.5 |
| Zn | <0.5 | <0.5 | <0.5 |
| Ti | 2 | <0.5 | <0.5 |
| Zr | <5 | <5 | <5 |
| P | 30 | <5 | <5 |

Note)
Preparation: Resin (pellet) sample was washed with nitric acid and decomposed by microwave, then, amount of metals in the decomposition was measured.

As shown in the Table 1, it is found that HDPE resin itself contains various kind of metals such as Na, Mg, Al, Ca, Ti, Zr and P in ppm order. Among these metals, Ca and P may come from stabilizing agents or metal neutralizers which is added at finishing stage of the polymer production. On the other hand, Mg, Ti, Zr, Al and the like are considered to be residues of catalysts in HDPE. Therefore, when HDPE is used as filter media, these metals shall elute into liquid and it causes quality degradation or faults of semi-conductors. Thus, metal elution is directly linked to decrease in the yield of semi-conductor. In recent circumstance where higher miniaturization of integrated circuit has been required for enhancing the degree of circuit integration, the filter media achieving higher purification of liquid than conventional is required.

This invention presents functional filter media for liquid purification which can effectively remove metals existing as metal compounds or ions in polishing liquid like alkali solution or ultra-pure water for washing silicon wafers applied for semi-conductors. This filter media is also utilized of purification of inorganic chemicals, organic solvents and the effluents in various industrial fields.

### SUMMARY OF THE INVENTION

Under such background, the present inventors have intensively studied new filter substrate suitable for metal collection/removal with less metal elution and as the result, found that Cyclic Olefin Copolymer (COC) obtained by copolymerizing cyclic olefin and ethylene using metallocene catalyst and/or Cyclic Olefin Polymer (COP) obtained by polymerizing polycyclic norbornene has a possibility to achieve extremely low metal elution to chemical liquid.

First in this invention, an interesting result was obtained by measuring metal contents in pellets of COC and COP in comparing with those of HDPE. The measurement results are shown in Table 1.

The Table 1 shows that contents of Na, Mg, Al, Ca, P, and the like in COC and COP are dramatically lower than those of HDPE and it is found that most of metal contents in

COC and COP are lower than the detection limit (0.5 ppm) of the analyzer.

Here, the difference of metal detected in HDPE, COC and COP can be clearly explained as follows.

Owing to recent progress of polymerization and the catalyst, most of HDPE can be produced without deliming (deashing), and then a kind of metallic soap must be added for neutralization, therefore, the most of catalysts made of metal compounds remain in HDPE as residues. On the other hand, COC or COP contains low amount of metals because deliming process is attached to these polymerization process. Therefore, the present inventors found a possibility to obtain a filter media with less metal elution, if COC or COP material is applied for the substrate of filter media.

For further studying, “melt-blown nonwoven fabrics” (described simply as “melt-blown nonwoven”, hereafter) was fabricated using these COC or COP in order to prepare the filter media substrate and to evaluate the degrees of metal elution to chemical liquid.

Later, as shown in several Examples, filter media made of monomer-grafted COC or COP melt-blown nonwoven showed lower metal elution compared with that of monomer-grafted HDPE melt-blown nonwoven. From this result, it is concluded that COC or COP melt-blown nonwoven are suitable substrate of filter media to remove trace metals in liquid.

However, the inventors of the present invention found that these COC and COP are extremely difficult materials to produce melt-blown nonwoven having tine fibers below 30 μm, because, they are amorphous and show no clear crystallization which contributes to smooth formation of melt-blown nonwoven.

The present inventors, as a result of intensive study on the condition of production of COC and COP melt-blown nonwoven, found that melt-blown nonwoven composed of fine fibers with excellent web appearance can be obtained, if the glass transition temperature (Tg, measured by ISO 11375-1,-2 and -3) and melt flow rate (MVR, measured by ISO 1133) are selected in a special range described hereinafter.

That is, according to the first aspect of the present invention, there is provided filter media for liquid purification made of melt-blown nonwoven substrate composed of an ethylene/norbornene copolymer represented by the following formula [1] and/or a polycyclic norbornene polymer represented by the following formulae [2] (a), (b), (c) as a raw material, wherein said ethylene/norbornene copolymer and said polycyclic norbornene polymer have a glass transition temperature (Tg, test method: ISO 11375-1,-2 and -3) selected in a range from 80 to 180° C. and melt volume rate (MVR, test method: ISO 1133, measuring conditions: 260° C., 2.16 kg) of 30 cm³/10 minutes or more, and wherein said melt-blown nonwoven substrate is constituted of fibers having an average fiber diameter ranging from 1 to 30 μm.

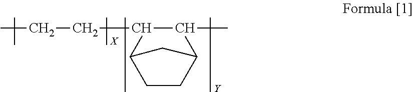

[wherein ethylene unit (X) or norbornene unit (Y) is chosen from 1 to 99 mole %.]

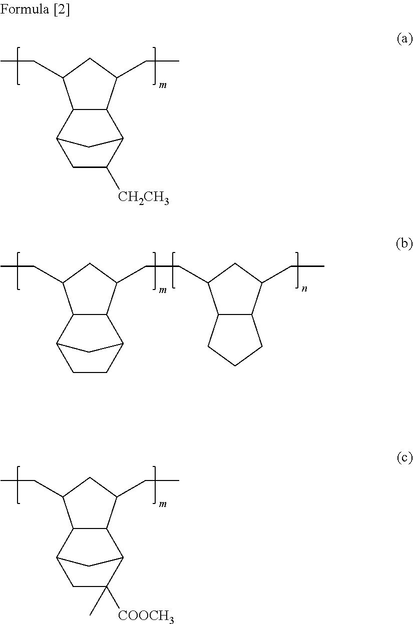

[wherein m and n represent degree of polymerization and is chosen from 1 or more, respectively.]

In addition, according to the second aspect of the present invention, there is provided filer media for liquid purification of the first aspect, wherein in the aforesaid melt-blown nonwoven substrate, at least one type of reactive monomer having vinyl group is graft-polymerized in a range from 40 to 200 parts by weight on the aforesaid melt-blown nonwoven substrate of 100 parts by weight and the reactive monomer having vinyl group is selected from acrylic acid, acrylonitrile, acrolein, N-vinylformamide, methyl acrylate, glycidyl methacrylate, vinylbenzyl glycidyl ether, chloromethylstyrene, ethyl styrenesulfonate ester, 2-acrylamide-2-methylpropanesulfonic acid, 2-hydroxyethyl methacrylate, mono(2-methacryloyloxyethyl) acid phosphate, di(2-methacryloyloxyethyl) acid phosphate, mono(2-acryloyloxyethyl) acid phosphate and di(2-acryloyloxyethyl) acid phosphate.

According to the third aspect of the present invention, there is provided filter media for liquid purification of the second aspect, wherein ring-opening treatment is applied on epoxy group of grafted glycidyl methacrylate or vinylbenzyl glycidyl ether.

In addition, according to the fourth aspect of the present invention, there is provided filter media for liquid purification of the second aspect, wherein an ion-exchange group and/or a chelate group has been introduced by conversion reaction to the aforesaid graft-polymerized melt-blown nonwoven substrate.

Further, according to the fifth aspect of the present invention, there is provided filter media for liquid purification of the fourth aspect, wherein the aforesaid ion-exchange group and/or chelate group is selected from at least one type of functional group contained in sulfone, amine, aminocarboxylic acids, phosphoric acids and thio-compound.

Until now, HDPE nonwoven substrate modified with graft polymerization is used as a filter media for removing trace metals and it has been considered as an excellent substrate of the filter media because of its high chemical and irradiation resistance, but under the requirement for higher level of purification, HDPE nonwoven substrate becomes unsuitable due to elution of metals from HDPE itself.

In contrast with the case of HDPE filter media, the filter media made of COC or COP can solve abovementioned issue and exhibit useful result in liquid purification with low elution and high metal removing performance.

### BRIEF DESCRIPTION OF THE DRAWINGS

FIG. 1 is a graph showing relationship between norbornene content and Tg in COC polymer relevant to the present invention.

### DETAILED DESCRIPTION OF THE INVENTION

The present invention is related to a filter media for liquid purification made of melt-blown nonwoven substrate composed of an ethylene/norbornene copolymer containing ethylene unit and norbornene unit represented by the following formula [1] and/or a polycyclic norbornene polymer represented by the following formulae [2] (a),(b) or (c).

Hereinafter, these materials are explained item by item as follows.

### 1. Cyclic Olefin Copolymer(COC)

The Cyclic Olefin Copolymer (COC) in the present invention means an ethylene/norbornene copolymer containing an ethylene unit and norbornene unit represented by the following formula [1] and such COC is produced by using a metallocene catalyst.

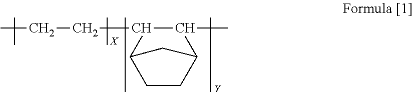

[wherein ethylene unit (X) or norbornene unit (Y) is chosen from 1 to 99 mole %.]

### 2. Cyclic Olefin Polymer(COP)

The Cyclic Olefin Polymer (COP) in the present invention means a polymer of polycyclic norbornene represented by of the following formulae [2] (a), (b), (c) which forms cycloolefin polymer.

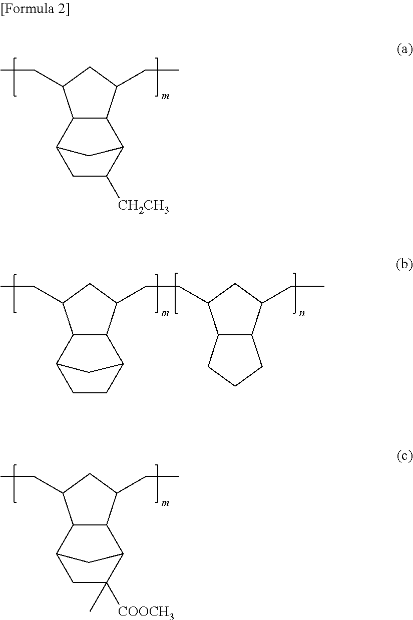

[wherein m and n represent degree of polymerization chosen from 1 or more, respectively.]

COC is obtained by vinyl type copolymerization of a cyclic olefin and ethylene and is commercially produced by synthesizing norbornene through Diels-Alder reaction of ethylene and cyclopentadiene and copolymerizing this norbornene and ethylene using a metallocene catalyst. Such COC is commercially produced and supplied by Polyplastics Co., Ltd. under the registered trade name “TOPAS”.

On the other hand, COP is produced and supplied from Mitsui Chemicals Inc. under the registered trade name “APEL”. The same kind of COP is produced and supplied from Zeon Corp. under registered trade name “ZEONOR”.

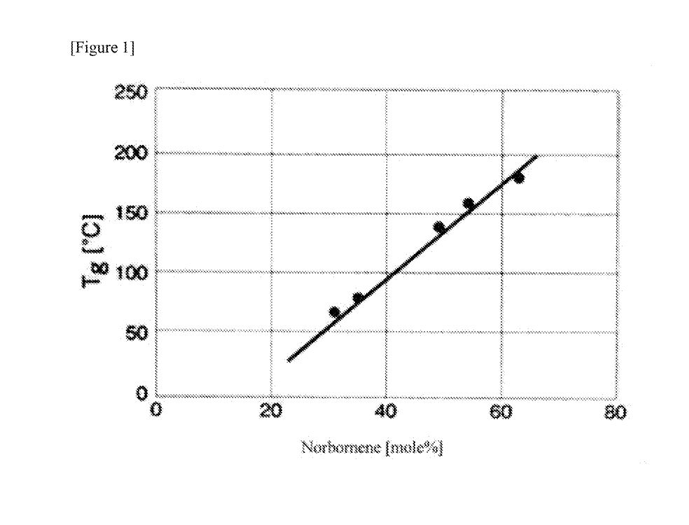

In copolymerization of COC, volume ratio of ethylene and norbornene can be flexibly chosen by making use of the linear correlation between Tg and norbornene content as shown in FIG. 1, so, the most suitable Tg for fabrication of melt-blown nonwoven can be obtained by choosing norbornene content of COC.

In the present invention, COC represented by formula [1] or COP represented by formula [2] is applied to fabricate melt-blown nonwoven composed of desirable fiber size by selecting Tg from its suitable range. Then, reactive monomer having vinyl group is grafted onto such COC or COP melt-blown nonwoven to provide metal adsorption function.

In particular, in the present invention, Tg of COC is preferably selected in range from 80 to 180° C. to provide heat resistance for the graft polymerization.

For the reference, the experimental correlation as shown in FIG. 1, the lowest Tg (80° C.) corresponds to 35 mol % of norbornene content and the highest Tg (180° C.) corresponds to 62 mol %, respectively.

According to the formula [1], content of ethylene unit (X) or norbornene unit (Y) can be chosen from 1 to 99 mole %, however, in the present invention, the content of ethylene unit (X) is preferably chosen from 38 to 65 mole % and the content of norbornene unit (Y) is preferably chosen from 35 to 62 mole %. Thus, COC having desirable Tg can be obtained.

On the other hand, it is necessary to control fiber diameter of melt-blown nonwoven in the range from 1 to 30 μm for this application. For such requirement, COC or COP having high MVR is selected to obtain such fine fiber diameter. In this invention, MVR of 30 cm³/10 minutes or more is necessary for obtaining fine fiber formation in melt-blowing nonwoven.

### 3. Melt-Blown Nonwoven Substrate

Melt-blown nonwoven substrate of COC or COP is obtained by continuous polymer melting in extruder and transferring the molten polymer to die nozzle, then, fiber spinning is carried out in hot air jet. The spinning fibers are simultaneously entangled in the air jet and collected on a conveyer to make continuous sheet-like nonwoven web. Self-fusion bonding of fibers is made at the landing on the conveyer to form nonwoven web and it is continuously taken up.

In the present invention, diameter of the fibers constituting COC or COP melt-blown nonwoven to be applied for graft polymerization should be controlled in a range from 1 to 30 μm as an average fiber diameter. In order to obtain such desirable fiber diameter in melt-blown nonwoven, melt viscosity of the polymer is extremely important. In particular, in order to achieve small fiber diameter, COC or COP having low melt viscosity must be fed to the die. In general, one of the methods to obtain low melt viscosity of COC or COP is to raise melt resin temperature in the die and extruder, however, it is limited because high temperature in excess of decomposition point (450° C.) causes carbon depositing by decomposition of the polymer.

Instead, in order to obtain fine fiber with an average diameter ranging from 1 to 30 μm, the present inventors have found that MVR of COC or COP should be selected higher than 30 cm³/10 min. If MVR of COC or COP is lower than 30 cm³/10 min, the melting temperature must be set at high level over than 400° C. and it shall cause decomposition and carbonization of polymer in the polymer line and the die nozzle.

Moreover, due to high melt viscosity of polymer, the spinning of fiber in jet air can not be fully formed and as the result, bead-like polymers called “lump” or “shot” frequently break out. Afterwards, uniform and smooth structure of the melt-blown nonwoven is not obtained using low MVR (i.e. high melt viscosity) polymer.

Now, from a standpoint of graft polymerization, fiber diameter of the nonwoven substrate plays important role as explained below.
(1) Since COC or COP is amorphous polymer, radicals generated by irradiation is not stably retained after irradiation in comparing with the case of crystalline polymer like HDPE. However, when fibers are fine, radicals is well retained on fiber surface because the melt-blown substrate composed of fine fibers has large specific surface area.
(2) Some of metals in a liquid exist as large colloids of metal oxides, hydroxides or gel-like low molecular weight polymers. So, when fiber diameter becomes fine, particles in liquid can be mechanically filtrated. Therefore, use of melt-blown nonwoven composed of fine fibers is advantageous to filtrate such colloidal impurities and it works synergistically well with ion-exchange group or chelate group added on the grafted melt-blown nonwoven.

Since melt-blown nonwoven process can provide one of the finest fiber composition among various nonwoven fabrication processes, the optimization of processing condition and selection of polymer become important from following reasons.

That is to say, melt-blown nonwoven is obtained by melt spinning, entanglement and self-fusion bonding between fibers to form nonwoven web, so, if self-fusion bonding is made insufficiently, fiber-to-fiber interaction cannot be fully developed, so, the most of fibers fly away and the melt-blown web turn to be much fluffy one. Due to such mechanism of melt-blown web formation, if Tg of the amorphous COC or COP is selected too high, solidification of fibers takes earlier than self-fusion bonding, hence, the fibers originate many “fly” and make the web fluffy.

For such problem, present inventors have found a counter measure that COC or COP having Tg lower than 180° C. should be selected to realize an appropriate self-fusion bonding to form smooth melt-blown web. On the other hand, when Tg is lower than 80° C., the melt-blown nonwoven cannot withstand the operation temperature of graft polymerization or conversion reaction. Moreover, such low Tg of COC or COP may cause significant deformation or shrinkage of the filter media in the usage.

To conclude, a desirable of Tg of COC or COP for obtaining fine appearance and high heat resistance of melt-blown nonwoven should be selected in a range from 80 to 180° C.,

In addition, as previously noted, it is also necessary to select proper MVR which conducts smooth fiber spinning to obtain finer size and if both of MVR and Tg are reasonably selected, a fine fiber structure with good appearance and high heat resistance of the melt-blown nonwoven can be realized. As the result of the study for selection of raw materials, i.e. COC and COP, and the production condition of melt-blown nonwoven, an suitable product range of melt-blown nonwoven for graft polymerization is found as shown below.
Average fiber diameter: in a range from 1 to 30 μm;
Basis weight: in a range from 20 to 100 g/m²;
Fiber packing density: in a range from 5 to 25%.

Here, it must be noted when the fiber packing density shown above is set less than 5%, the melt-blown nonwoven becomes too fluffy and weak due to loose fiber bonding.

On the other hand, when high fiber packing density is set over than 25%, too much compact and dense structure like film sheet is obtained. In this case, it is not preferable because the grafting monomer cannot smoothly penetrate into the inside of melt-blown nonwoven and it does not provide sufficient spaces for the growing of graft polymer in the melt-blowing nonwoven.
Here, fiber packing density is defined and calculated by following formula.

Fiber packing density (%)=100×[Basis Weight g/m²]/[Thickness mm]/[Resin specific gravity]/1,000

### 4. Method of Graft Polymerization.

Graft polymerization of reactive monomer having vinyl group is performed onto COC or COP melt-blown nonwoven substrate through following three steps.

### (Step I):

COC or COP Melt-blown nonwoven substrate is irradiated by gamma ray or electron beam to generate radicals. Irradiation dose is executed in a range from 50 to 200 kGy. When irradiation dose is given less than 50 kGy, desirable graft ratio cannot be obtained due to poor generation of radicals. On the other hand, irradiation dose in excess of 200 kGy is not preferable, because substrate is severely damaged and the polymer degradation is induced. In addition, the irradiated substrate should be kept below −20° C. over Step I and transferring period to Step II in order to prevent deactivation of radicals.

### (Step II):

Such irradiated COC or COP melt-blown nonwoven substrate is immersed in reactive monomer having vinyl group to build up graft polymerization. In the present invention, in order to provide high graft ratio, it is necessary to use emulsified reactive monomer by homogenizing with water and surfactant. At the same time, the concentration of oxygen dissolved in the emulsion is necessary to be controlled less than 1% through vacuum deaeration or nitrogen gas bubbling.

According to the method above-described, graft polymerization of various types of monomers can be applied on COC or COP melt-blown nonwoven substrate.

In the present invention, graft ratio with a range from 40 to 200%, more preferablly from 80 to 150%, is desirable to give long life of filtration/purification.

The graft ratio is controlled by irradiation dose, concentration of monomer emulsion, reaction temperature, reaction time and it is defined by following formula.

Graft ratio (%)=100×(B−A)/A

wherein A represents the basis weight(g/cm²) of nonwoven substrate before graft polymerization and B represents the basis weight (g/cm²) of nonwoven substrate after graft polymerization.

The reactive monomer to be graft-polymerized onto COC or COP melt-blown nonwoven substrate through Step II is selected from monomers having vinyl group, that is, acrylic acid, acrylonitrile, acrolein, N-vinylfolmamide, methyl acrylate, glycidyl methacrylate (GMA), vinylbenzyl glycidyl ether, chloromethylstyrene (CMS), ethyl styrenesulfonate ester, 2-acrylamide-2-methylpropanesulfonic acid, 2-hydroxyethyl methacrylate, and the like. In addition, vinyl monomer having phosphoric acid group contained in mono-(2-methacryloyloxyethyl) acid phosphate, di-(2-methacryloyloxyethyl) acid phosphate, mono-(2-acryloyloxyethyl) acid phosphate, di-(2-acryloyloxyethyl) acid phosphate, or mixture thereof, and the like can be selected.

### 5. Addition of Ion-Exchange Group and Chelate Group

### (Step III):

In the present invention, ion-exchange group or chelate group is introduced by conversion reaction to graft polymerized nonwoven substrate. Such functional groups have capability to adsorb metals dissolved in liquid.

Here, the functional monomer having ion-exchange group is selected from a type of sulfo group contained in sulfonic acid, a type of amino group contained in primary amine, secondary amine, tertialy amine amine and a type of group contained in aminocarboxylic acids, phosphoric acid and thio-compounds.

The functional monomer having chelate group is selected from a type of chelate group contained in iminodiethanol and aminocarboxylic acids like aminoacetic acid, nitrilotriacetic acid, ethylenediaminetetraacetic acid, diethylenetriaminepentaacetic acid, triethylenetetraminehexaacetic acid, glutaminediacetic acid, ethylenediaminedisuccinic acid and iminodiacetic acid.

In addition to functional monomers stated above, a kind of amine contained in ethylendiamine, diethylenetriamine, triethylenetetramine, polyethytlenepolyamine, polyethyleneimine, polyallylamine, pyrrole, polyvinylamine or Schiff's base can be selected.

Further, as a functional monomer, a kind of hydroxylamine contained in oxim, amidoxim, oxine (8-oxyquinoline), glucamine, dihydroxyethylamine and hydroxamic acid can be selected.

In addition to functional monomers stated above, a kind of phosphoric acid group contained in aminophosphoric acid or phosphoric acid can be selected. Furthermore, as a functional monomer, thio-compounds contained in thiol, thiocarboxylic acid, dithiocarbamic acid or thiourea can be selected.

### EXAMPLES

The present invention shall be explained in detail based on the following Examples.

### Example 1 and Comparative Example 1

### Preparation of Melt-Blown Nonwoven Substrate

As a raw material in Example 1, COC (“TOPAS 5013” produced by Polyplastics Co., Ltd.,) having Tg of 134° C. and MVR (measured at 260° C., 2.16 kg) of 48 cm³/10 min was selected.

Also, as a raw material in Comparative Example 1, COC (“TOPAS 6013” produced by Polyplastics Co., Ltd.,) having Tg of 138° C. and MVR (measured at 260° C., 2.16 kg) of 14 cm³/10 min was selected.

In using two types of COC having such different MVR, melt-blown nonwovens with continuous length having 30 cm width were fabricated and continuously taken up. In this melt-blown operation, spinning die nozzles of 0.4 mm hole diameter was used and the operation temperature was set close to 300° C. Regarding COC polymer, “TOPAS 5013”, melt-blown nonwoven having average fiber diameter ranging from 1 to 30 μm was smoothly obtained. (Example 1)

On the other hand, regarding COC polymer “TOPAS 6013”, un-spun molten polymers, i.e. called “lump” or “shot”, break out very often and as the result of the melt-blown operation, fine fibers thinner than 30 μm could not be smoothly obtained. (Comparative Example 1)

Moreover, as molten resin pressure at die nozzle has risen, so, a risk of damage of the die nozzle came out and it was caused by its high melt viscosity of “TOPAS 6013”, so, it is concluded that the use of low MVR (i.e. high melt viscosity) COC or COP resins is not suitable for fabrication of melt-blown nonwoven. According to the study, following COC melt-blown nonwoven substrate of Example 1 was prepared as shown below.

### (Details of COC Melt-Blown Nonwoven in Example 1)

COC raw material: “TOPAS 5013”(MVR 48) produced by Polyplastics Co., Ltd.)
Basis weight: 60 g/m²;
Thickness: 0.5 mm;
Air permeability: 17 cc/cm²/sec;
Fiber packing density: 12%;
Average fiber diameter: 6 μm.

### Example 2

As another Example of filter substrate, COP, “ZEONOR 1060R” (produced by Zeon Corp.) having Tg of 100° C. and MVR (at 260° C., 2.16 kg) of 50 cm³/10 minutes was selected for Example 2.

A melt-blown nonwoven fabric with 30 cm width was continuously fabricated using spinning die nozzles of 0.4mm hole diameter and the operation temperature was set close to 300° C. Regarding “ZEONOR 1060R”, a nonwoven fabric having uniform fiber diameter in a range from 1 to 30 μm was smoothly obtained. According to the study, following COP melt-blown nonwoven for Example 2 was prepared as shown below.

### (Details of COP Melt-Blown Nonwoven in Example 2)

Basis weight: 60 g/m²;
Thickness: 0.5 mm;
Air permeability: 17 cc/cm²/sec;
Fiber packing density: 12%;
Average fiber diameter: 6 μm.

### Comparative Example 2

A melt-blown nonwoven made of HDPE (Melt Index=40) was prepared in order to examine the degree of metal elution. Following melt-blown nonwoven sample was prepared as almost the same as in Example 1 or Example 2.

### (Details of HDPE Melt-Blown Nonwoven in Comparative Example 2)

Basis weight: 60 g/m²;
Thickness: 0.45 mm;
Air permeability: 18 cc/cm²/sec;
Fiber packing density: 11%;
Average fiber diameter: 6 μm.

### (Metal Elution Test)

The metal elution tests on Example 1(COC), Example 2(COP) and Comparative Example 2 (HDPE) were carried out and the test samples named “Sample(i)” were examined as shown from Table 2 to Table 5. From these test results, it is found that level of metal elution from COC and COP nonwoven substrates were very low in comparing with those of HDPE.

### Example 3

### (Addition of Iminodiethanol Group)

Using the COC melt-blown nonwoven(obtained in Example 1) and the COP melt-blown, nonwoven(obtained in Example 2), filter media having metal adsorbing function were prepared through following Steps.

### (Step I)

The COC and COP melt-blown nonwoven substrate “Sample(i)” obtained in Example 1 and Example 2 were placed under freezing condition with dry ice and then gamma ray of 100 kGy was irradiated thereto. After the irradiation, the melt-blown nonwoven substrates were stored in a freezer controlled at −40° C. till executing next Step II.

### (Step II)

The irradiated nonwoven substrates were immersed in emulsion containing 5% of glycidyl methacrylate (GMA). The emulsion was prepared by adding 5% of GMA and 0.5% of surfactant (“Tween 20” produced by Kanto Chemical Co., Inc.,) into ultra-pure water and homogenized using a stirrer. In addition, nitrogen bubbling was applied to purge oxygen dissolved in the emulsion down to 1% or less. The graft polymerization was conducted in the emulsion kept at 40° C. for 2 hours.

As the result of this operation, 120% of graft ratio was obtained for both of COC and COP melt-blown nonwoven substrate. (These samples are named “Sample(ii)” in Example 3

### (Step III)

Subsequently, these GMA-grafted nonwoven substrates were immersed in iminodiethanol(IDE) filled in a tank kept at 80° C. for 4 hours for conversion reaction with the grafted GMA polymer. As the result, conversion of IDE group to epoxy group of GMA reached 2.0 m-mol/g in each COC and COP melt-blown nonwoven substrate. (These samples are named “Sample(iii)” in Example 3.)

### Comparative Example 3

For comparison, GMA-graft polymerization on HDPE melt-blown nonwoven “Sample(i)” obtained in Comparative Example 2 was carried out in same manner described in Step II. As the result of graft polymerization with GMA, 135% of the graft ratio was obtained. (This sample is named “Sample (ii)” in Comparative Example 3.) In succeeding Step III, IDE conversion reaction was conducted. After that, IDE converted on grafted GMA reached 2.3 m-mol/g. (This sample is named “Sample (iii)” in Comparative Example 3.)

The elution tests on these “Samples” obtained in Example 3 and the Comparative Example 3 were conducted for the comparison as described hereafter.

### (Details of Metal Elusion Test: Testing Samples, Liquids and the Test Results)

Using the “Samples” obtained in Examples 1, 2 and 3 and Comparative Examples 2 and 3, degree of elution to ultra-pure water and 0.1 N nitric acid were examined as follows.

### [Elution Test to Ultra-Pure Water and the Testing Samples]

At first, the elution test for ultra-pure water was carried out on three kinds of “Samples” (i), (ii) and (iii) made of HDPE-based melt-blown nonwoven obtained in Comparative Example 2 and 3, respectively. The test result is summarized as shown in Table 2.

In the same manner, the elution test for ultra-pure water was carried out on three kinds of “Samples” (i), (ii) and (iii) made of COC or COP-based melt-blown nonwoven obtained in Example 1, 2 and 3, respectively. The test result is summarized as shown in Table 3. Here, “Sample(iv)” represents ultra-pure water as the original liquid used for elution test. The elution time elution was set for 24 hours at room temperature.

### [Elution Test to 0.1 N Nitric Acid and the Testing Samples]

In a same manner, the elution test for 0.1N nitric acid was carried out on HDPE-based “Sample(i), (ii) and (iii)” as shown in Table 4 in comparing with the elution test results of COC and COP-based “Sample(i), (ii) and (iii)” as shown in Table 5. Here, “Sample(iv)” represents 0.1N nitric acid as the original liquid for elution test. The immersion time for elution was set for 24 hours at room temperature.

For reference to make clear the description of various “Samples” abovementioned, following annotations on “Sample (i), (ii), (iii) and (iv)” are given below.
Sample (i): Original(untreated) melt-blown nonwoven made of COC, COC and HDPE obtained in Example 1, 2 and Comparative Example 2.
Sample (ii): GMA-grafted samples using above Samples (i)
Sample (iii): IDE conversion-treated samples using above Samples (ii)
Sample (iv): Original liquid used in the elution test, i.e. ultra-pure water and 0.1N nitric acid.

### [Result of Elution Test for Original Melt-Blown Nonwoven]

Elution to ultra-pure water and 0.1N nitric acid in case of Original melt-blown nonwoven “Sample(i)” was examined as shown in Table 2/Table 3 and Table 4/Table5.

In this Table 2, it is found that the elution of Fe, Ni and Zn eluted from HDPE melt-blown nonwoven is comparatively high, whereas COC and COP melt-blown nonwovens gave very low (un-detectable) level as shown in Table 3.

### [Result of Elution Test for GMA-Grafted and IDE-Treated Melt-Blown Nonwoven]

In parallel with the elution test on these original melt-blown nonwoven, elution tests on GMA-grafted and IDE conversion-treated “Sample(ii) and (iii)” of each HDPE, COC and COP-based melt-blown nonwoven were conducted and the test results are summarized in Table 2/Table 3 and Table 4/Table 5. It is also pointed out that high level of Fe, Ni and Zn eluted from HDPE-based “Sample(ii) and (iii)” was found, whereas COC and COP-based “Sample (ii) and (iii)” gave very low (un-detectable) level.

In viewing over the test results through Table 2 to Table 5, the metal eluted from COC and COP-based “Samples” show undetectable values and they are extremely low in comparing with those from HDPE-based “Samples”.

From the comparison among these elution test results, following conclusions were obtained.
1) For ultra-pure water, metal elution of the GMA-grafted Samples(ii) and the IDE conversion-treated Samples(iii) of COC and COP-based melt-blown nonwoven substrates were very low as shown in Table 3 in comparing with those of HDPE-based melt-blown nonwoven substrates as shown in Table 2.
2) For 0.1N nitric acid, metal elution of the GMA-grafted Sample(ii) and the IDE conversion-treated Sample(iii) of COC and COP-based melt-blown nonwoven substrates were very low as shown in Table 5 in comparing with those of HDPE-based Sample(ii) and (iii) as shown in Table 4.

Such difference is considered as the reflection of the metal content of each original raw material, HDPE, COC and COP as shown in Table 1. Conclusively, it becomes clear that COC or COP melt-blown nonwoven and its functionalized nonwoven substrate through graft polymerization provide lower metal elution than those of HDPE-based melt-blown nonwoven substrate.

From another aspect, filtration of 4% 2-hydroxyethyltrimethylammonium hydroxide aqueous solution (“Choline” produced by Tama Chemicals Co., Ltd.) was conducted using filter media of IDE-functionalized COC and COP nonwoven substrate “Sample(iii)” obtained in Example 3. Through the filtration, reduction of metal concentration in the liquid was clearly recognized. For instance, Fe reduced from 70 ppb to 0.02 ppb, Ni reduced from 0.01 ppb to the level less than 0.01 ppb and Zn reduced from 0.18 ppb to 0.04 ppb.

Contrarily, when HDPE melt-blown substrate having IDE group (“Sample (iii)” obtained in Comparative Example 3) was used for the filtration of the Choline aqueous solution, increase in Al concentration after filtration was recognized.

### (Measured Al Concentration in ppb Before/After Filtration of Choline Aqueous Solution)

Before filtration: 0.05 ppb

After filtration: 0.23 ppb

The cause of such increase in Al concentration is considered due to elution of catalyst residues from HDPE.
Note: The original testing liquid used in this test was preliminary condensed before executing metal analysis and ICP-MS (manufactured by PerkinElmer Inc., ELAN DRC-II) was used for metal analysis.

### Example 4

### (Addition of Sulfo Group)

As Example 4, sulfo group was added on GMA-grafted COC and COP melt-blown nonwoven substrate obtained through conversion reaction (Step III).

In the sulfonation treatment, GMA graft-polymerized nonwoven (“Sample (ii)” of COC and COP obtained in Example 3) were immersed in 10% sodium sulfite aqueous solution maintained at 80° C. for 2 hours to add sulfo group. The sulfo group converted to epoxy group of GMA reached 2.6 mmol/g for both COC and COP nonwoven substrate.

In succeeding examination, the filtration test using ultra-pure water prepared by

Minipure TW-300RU (made by Nomura Micro Science Co., Ltd.) was conducted. The metals in original ultra-pure water before filtration were detected as shown below, whereas all of metals after filtration were reduced down to 0.01 ppb or less. Especially, Al was not detected after the filtration.

(Measured Concentration in Original Ultra-Pure Water before Filtration)
Before filtration:
Na (0.3 ppb), Mg (0.01 ppb), Al (0.01 ppb), K (0.01 ppb), Ca (0.2 ppb), Cr (0.01 ppb),
Mn (0.01 ppb), Fe (0.03 ppb), Ni (0.08 ppb), Cu (0.01 ppb), Zn (0.09 ppb), Ti (0.01 ppb),
Zr (0.01 ppb) and P (0.01 ppb)
After filtration: All metals were reduced down to 0.01 ppb or less.

### Example 5

### (Addition of Glucamine Group)

Glucamine group was added through conversion reaction on GMA-grafted COC and COP melt-blown nonwoven(“Sample (ii)” obtained in Example 3). The glucamine treatment was conducted through Step III as described before. In the glucamine treatment, methanol was used as the solvent of glucamine. GMA-grafted melt-blown nonwoven of COC and COP (obtained in Example 3) were immersed in the glucamine solution at 80° C. for 2 hours. As the result, the glucamine group converted to epoxy group of GMA reached 2.6 m-mol/g for both COC and COP nonwoven substrate.

In succeeding examination, filtration test using 48% NaOH (“Clearcut-S” produced by Tsurumi Soda Co., Ltd.) was conducted and the metal concentration in the liquid before and after filtration were measured.

### (Measured Concentration in ppb Before/After Filtration)

Ni: 0.5 ppb before filtration/0.01 ppb after filtration

Cu: 0.03 ppb before filtration/0.01 ppb after filtration

Al was not detected after the filtration. From the result of analysis, metal removal effect of glucamine group was recognized.

### Example 6

### (Addition of Iminodiacetic Acid Group)

Chloromethylstyrene (CMS) as a reactive graft monomer was introduced on the COC and COP melt-blown nonwoven (“Sample(i)” obtained in Example 1 and 2). Graft polymerization on these melt-blown nonwoven substrates were carried out through the manner as described in Step II.

As grafting monomer, emulsified CMS was prepared by using surfactant called “Tween” and ultra-pure water. The graft polymerization was carried out by immersion at 50° C. for 3 hours. As the result, 100% of CMS graft ratio both for COC and COP substrate were obtained.

Successively, the CMS-grafted COC and COP nonwovens were subjected to conversion reaction at 80° C. for 7 hours in the solution of sodium iminodiacetate(IDA). Isopropanol was used as the solvent of IDA.

Afterwards, IDA-treated samples were washed with 0.2 N NaOH and ultra-pure water to finish a filter media sample. As the result of this conversion treatment, reacted IDA group on CMS-grafted COC and COP nonwoven substrate reached 2.8 m-mol/g.

Using such filter media, 30% potassium carbonate aqueous solution (produced by Wako Pure Chemical Industries, Ltd.) was filtrated. As the result of filtration, every 50 ppb concentration level of Fe, Ni and Zn in the liquid was reduced down to 0.1 ppb or less and Al was not detected.

TABLE 2
Metal concentration detected in ultra-pure water
after the elution test of HDPE nonwoven

Unit: ppb

| Kind of | Lower limit | Sample | Sample | Sample | Sample |
|---|---|---|---|---|---|
| Metal | of analysis | (i) | (ii) | (iii) | (iv) |
| Na | 1 | 810 | 230 | 4 | ND |
| Mg | 0.1 | 12 | 100 | 13 | ND |
| Al | 0.1 | 7.2 | 0.6 | 0.3 | ND |
| K | 100 | 3,800 | ND | ND | ND |
| Ca | 500 | ND | ND | ND | ND |
| Cr | 0.5 | ND | ND | ND | ND |
| Mn | 0.05 | ND | 0.09 | 0.22 | ND |
| Fe | 0.01 | 1 | 0.4 | 0.4 | ND |
| Ni | 0.1 | 0.3 | 0.1 | ND | ND |
| Cu | 0.05 | 0.55 | 0.11 | ND | ND |
| Zn | 0.5 | 1.7 | 1.2 | 3.4 | ND |
| Ti | 0.5 | 14 | ND | ND | ND |
| Zr | 50 | ND | ND | ND | ND |
| P | 50 | 2,900 | 230 | 110 | ND |

Sample (i): Untreated (original) nonwoven substrate
Sample (ii): GMA-grafted nonwoven substrate
Sample (iii): Iminodiethanol group-converted nonwoven substrate
Sample (iv): Original Ultra-pure water for testing liquid

TABLE 3
Metal concentration detected in ultra-pure water
after the elution test of COC and COP nonwoven

Unit: ppb

| Kind of | Lower limit | Sample | Sample | Sample | Sample |
|---|---|---|---|---|---|
| Metal | of analysis | (i) | (ii) | (iii) | (iv) |
| Na | 1 | ND | ND | ND | ND |
| Mg | 0.1 | ND | ND | ND | ND |
| Al | 0.1 | ND | ND | ND | ND |
| K | 100 | ND | ND | ND | ND |
| Ca | 500 | ND | ND | ND | ND |
| Cr | 0.5 | ND | ND | ND | ND |
| Mn | 0.05 | ND | ND | ND | ND |
| Fe | 0.01 | ND | ND | ND | ND |
| Ni | 0.1 | ND | ND | ND | ND |
| Cu | 0.05 | ND | ND | ND | ND |
| Zn | 0.5 | ND | ND | ND | ND |
| Ti | 0.5 | ND | ND | ND | ND |
| Zr | 50 | ND | ND | ND | ND |
| P | 50 | ND | ND | MD | ND |

Sample (i): Untreated(original) nonwoven substrate
Sample (ii): GMA-grafted nonwoven substrate
Sample (iii): Iminodiethanol group-converted nonwoven substrate
Sample (iv): Original Ultra-pure water for testing liquid

TABLE 4
Metal concentration detected in 0.1N nitric
acid after the elution test of HDPE nonwoven

Unit: ppb

| Kind of | Lower limit | Sample | Sample | Sample | Sample |
|---|---|---|---|---|---|
| Metal | of analysis | (i) | (ii) | (iii) | (iv) |
| Na | 1 | 1,500 | 530 | 12 | ND |
| Mg | 0.1 | 57 | 160 | 36 | ND |
| Al | 0.1 | 8.1 | 4.7 | 6.5 | ND |
| K | 100 | 5,000 | 100 | ND | ND |
| Ca | 500 | ND | 600 | ND | ND |
| Cr | 0.5 | ND | 0.1 | ND | ND |
| Mn | 0.05 | 0.23 | 0.34 | 0.32 | ND |
| Fe | 0.01 | 1.2 | 0.7 | 9 | 0.01 |
| Ni | 0.1 | 1.9 | ND | 0.1 | ND |
| Cu | 0.05 | 1.3 | 1.9 | 0.98 | ND |
| Zn | 0.5 | 6.3 | 4.8 | 5.3 | ND |
| Ti | 0.5 | 8.4 | 1.5 | 2 | ND |
| Zr | 50 | ND | ND | ND | ND |
| P | 50 | 2,500 | 340 | 110 | ND |

Sample (i): Untreated nonwoven substrate (original fabric)
Sample (ii): GMA-grafted nonwoven substrate
Sample (iii): Iminodiethanol group-converted nonwoven substrate
Sample (iv): Original 0.1N nitric acid for testing liquid

TABLE 5
Metal concentration in 0.1N nitric acid after
the elution test of COC and COP nonwoven

Unit: ppb

| Kind of | Lower limit | Sample | Sample | Sample | Sample |
|---|---|---|---|---|---|
| Metal | of analysis | (i) | (ii) | (iii) | (iv) |
| Na | 1 | ND | ND | ND | ND |
| Mg | 0.1 | ND | ND | ND | ND |
| Al | 0.1 | ND | ND | ND | ND |
| K | 100 | ND | ND | ND | ND |
| Ca | 500 | ND | ND | ND | ND |
| Cr | 0.5 | ND | ND | ND | ND |
| Mn | 0.05 | ND | ND | ND | ND |
| Fe | 0.01 | ND | ND | ND | 0.01 |
| Ni | 0.1 | ND | ND | ND | ND |
| Cu | 0.05 | ND | ND | ND | ND |
| Zn | 0.5 | ND | ND | ND | ND |
| Ti | 0.5 | ND | ND | ND | ND |
| Zr | 50 | ND | ND | ND | ND |
| P | 50 | ND | ND | MD | ND |

Sample (i): Untreated nonwoven substrate (original fabric)
Sample (ii): GMA-grafted nonwoven substrate
Sample (iii): Iminodiethanol group-converted nonwoven substrate
Sample (iv): Original 0.1N nitric acid for testing liquid

### Example 7

Ring-opening treatment on GMA-grafted melt-blown nonwoven substrate (obtained in Example 3 step II) was performed to examine the capability of metal adsorption by filtrating 48% KOH aqueous solution. The ring-opening treatment was made by immersing the GMA-grafted nonwoven substrate into 1N sulfuric acid at 80° C. for 2 hours. In this treatment, the epoxy-group is converted to diol-group.

On this filter media, 48% KHO filtration test was performed and metal concentration regarding Ni and Cu were measured.

TABLE 6
Metal concentration detected in 48%
KOH before and after filtration

Unit; ppb

| | Before | | |
|---|---|---|---|
| | filtration | Amount of detected metal in 48% KOH | |
| Metal | 48% KOH | after filtration | |
| con- | (original | GMA-grafted nonwoven | GMA-grafted nonwoven |
| tained | liquid) | without ring-opening | with ring-opening |
| Ni | 2 | 1 | 1 or less |
| Cu | 6 | 5 | 1 or less |

As shown in Table 6, it was found that 2 ppb of Ni in original 48% KOH solution was reduced down to 1 ppb or less and 6 ppb of Cu in 48% KOH reduced down to 1 ppb or less by the ring-opening treatment on grafted GMA. Thus, metal removal effect of ring-opening was recognized.

The filter media of the present invention is utilized for removal of trace metals in various liquids used in semi-conductor industries. As the degree of purification is improved, the yield of production increase and also recycle of used liquids are realized, therefore, it can provide an effective measure for environmental protection.

What is claimed is:

1. Filter media for liquid purification made of melt-blown nonwoven substrate composed of an ethylene/norbornene copolymer represented by the following formula [1] and/or a polycyclic norbornene polymer represented by the following formulae [2](a),(b),(c) as raw material, wherein said ethylene/norbornene copolymer and said polycyclic norbornene polymer have a glass transition temperature (Tg, ISO11375-1,-2,-3) selected in a range from 80 to 180° C. and a melt volume rate (MVR, ISO 1133, measuring conditions: 260° C., 2.16 kg) of 30 cm³/10 minutes or more, and wherein said melt-blown nonwoven fabric substrate is constituted of fibers having an average fiber diameter from 1 to 30 μm. 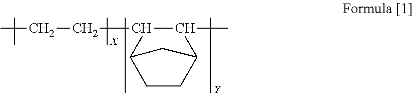
[wherein ethylene unit (X) or norbornene unit (Y) is chosen from 1 to 99 mole %.] 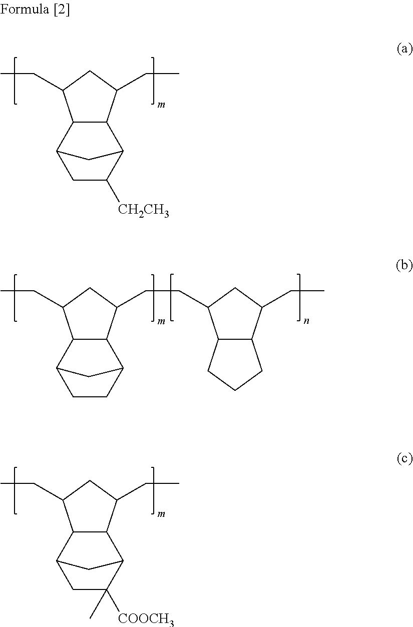
[wherein m and n represent degree of polymerization and it is chosen from 1 or more, respectively.]

2. The filter media for liquid purification according to claim 1, wherein in the aforesaid melt-blown nonwoven substrate, at least one type of reactive monomer having vinyl group is graft-polymerized in a range from 40 to 200 parts by weight on the aforesaid melt-blown nonwoven substrate of 100 parts by weight and the reactive monomer having vinyl group is selected from acrylic acid, acrylonitrile, acrolein, N-vinylformamide, methyl acrylate, glycidyl methacrylate, vinylbenzyl glycidyl ether, chloromethylstyrene, ethyl styrenesulfonate ester, 2-acrylamide-2-methylpropanesulfonic acid, 2-hydroxyethyl methacrylate, mono(2-methacryloyloxyethyl) acid phosphate, di(2-methacryloyloxyethyl) acid phosphate, mono (2-acryloyloxyethyl) acid phosphate and di(2-acryloyloxyethyl) acid phosphate.

3. The filter media for liquid purification according to claim 2, wherein ring-opening treatment is applied on grafted epoxy-group of glycidyl methacrylate or vinylbenzyl glycidyl ether.

4. The filter media for liquid filtration according to claim 2, wherein an ion-exchange group and/or a chelate group has been introduced to the aforesaid grafted polymer on melt-blown nonwoven substrate.

5. The Filter media for liquid purification according to claim 4, wherein the aforesaid ion-exchange group and/or chelate group is selected from at least one type of functional group contained in sulfone, amine, aminocarboxylic acids, phosphoric acids and thio-compound.
